(19) United States
(12) Patent Application Publication
(10) Pub. No.: US 2003/0113693 A1
(43) Pub. Date: Jun. 19, 2003

(54) Simple programmable computer

(76) Inventor: Tamer Yunten, Blacksburg, VA (US)

Correspondence Address: James W. Hiney, Esq., Suite 1100, 1872 Pratt Drive, Blacksburg, VA, 24060, US

(21) Appl. No.: 09/757,273

(22) Filed: Jan. 10, 2001

(51) Int. Cl. G09B 19/00

(52) U.S. Cl. 434/118

(57) ABSTRACT

A simple computer comprising a group of individual sub-circuits that can be plugged together in several ways to form an operating computer. The invention is used to teach students the basic components of a computer and to demonstrate how each sub-system works and its interrelationship with the other sub-systems. The invention is designed so that it can be easily assembled and disassembled and the components are readily visible to the students.

This invention relates to a simple programmable computer to be used in teaching computer basics in the classroom whether in computer science, engineering, physics, electronics or any other class of any curriculum where the basics of computer operation and interrelationship with programming needs to be taught as well as the internal architecture of commercial computers. This invention is also intended for use of individuals outside of the classroom for self-teaching purposes.

### GENERAL DESCRIPTION

The computer that forms the basis for this invention is to be used as a teaching aid only. It is not a complete commercial computer that allows for word processing, advanced gaming, or any other of the many complicated tasks that modern computers are capable of. It is solely a teaching aid for answering the many questions of the engineer, scientist, student, hobbyist or just curious.

The teaching aid will help answer many questions that the average person has about computers which include the following as well as other questions.

1. What is machine language?

2. What is a computer processor?

3. What is an Arithmetic Logic Unit? How is it implemented?

4. What is a Control Unit? How is it implemented?

5. What is a bit? . . . a byte? . . . How are these implemented?

6. What is Random Access Memory?

7 How is a program stored in Random Access Memory?

8. What is a Central Processing Unit?

9. How does a Central Processing Unit retrieve program instruction from The Random Access Memory?

10 How does a Central Processing Unit execute program instructions?

11. How are these instructions implemented?

12. What is a computer clock and what does it do?

13. What do computer chips look like and how are they interconnected?

These are but a few of the many questions that arise from students and the curious regarding computers and this instant teaching aide is designed to assist the instructor or teacher in teaching these basics of computer operation.

The teaching aide is packaged in a kit so as to enable the student to build the aid right in class under the tutelage of the instructor and/or outside the class via personal study. It contains a complete set of components and a comprehensive instruction manual to guide the teacher and the student in implementing the computer teaching aid.

The teaching aid represents the functional architecture of today's computers and teaches the fundamental concepts of modern-day computers with hands-on experience by having the student build a simplified version of today's computers.

The student learns to build a Central Processing Unit, a CPU, implement the Unit, implement an arithmetic unit, implement instruction fetch and execution cycles, implement four basic machine language instructions, connect a Random Access Memory, a RAM, to the CPU, and program the RAM with machine instructions that he or she implements, and monitors how the CPU executes the programs.

The package comes with circuit chips, breadboard, power-supply, switches, wire, light emitting diodes (LED), resistors, capacitor, and a lab instruction manual.

Accordingly, it is an object of this invention to provide a computer teaching aid that is programmable, and

It is a further object of this invention to provide a programmable teaching system for instructing students to build a simple computer, and

Another object of this invention to provide a simplified computer which performs only basic functions but nevertheless is programmable for teaching students computer operation, and

A still further object of this invention is to provide a kit for teaching students the fundamentals of computer operation, and

Yet another object of this invention is to provide a package containing a RAM, a set of small scale integrated circuit chips and the other necessary components for assembling a teaching aid that is programmable, and

These and other objects of this invention will become apparent when reference is had to the accompany drawings in which:

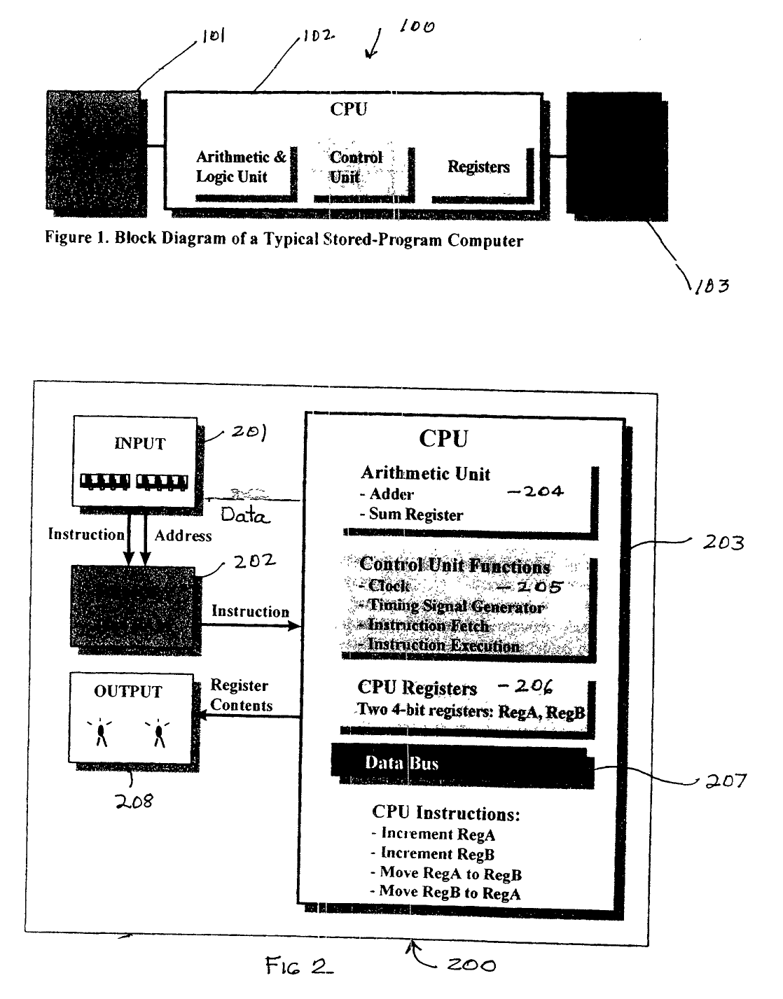

FIG. 1 is a block diagram of a typical stored-program computer,

FIG. 2 shows the simple computer that is built by the student, and

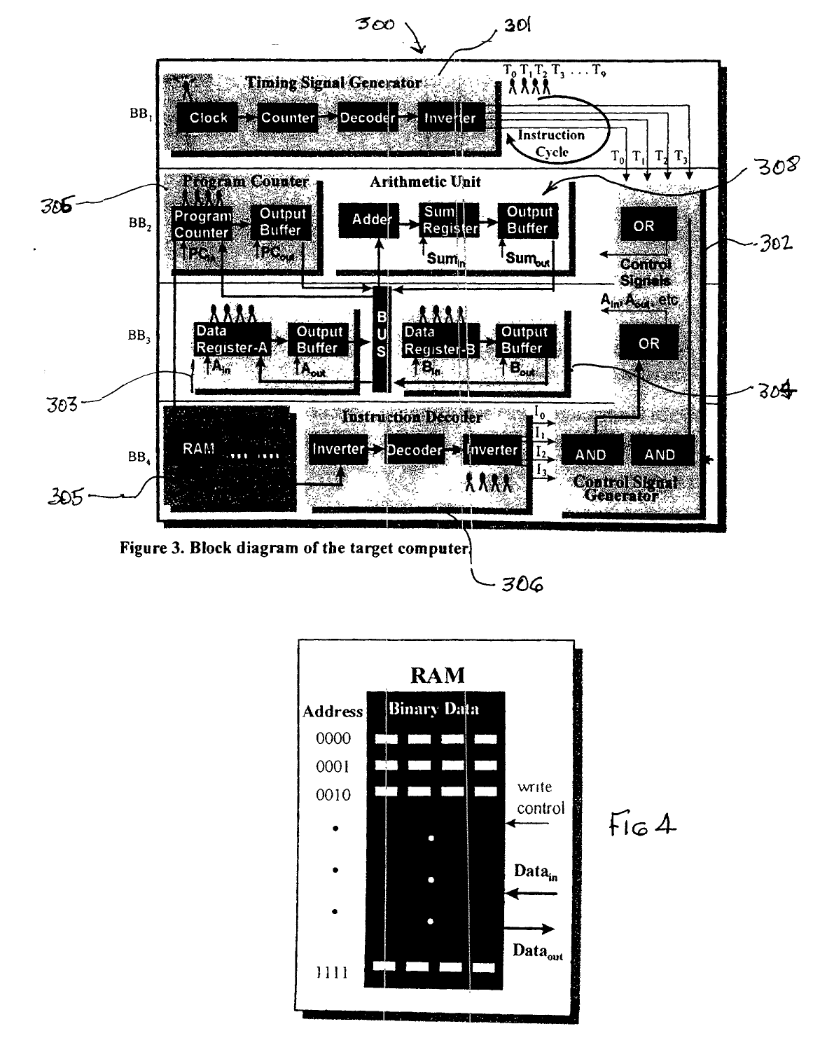

FIG. 3. is a detailed block diagram of the simple computer,

### DETAILED DESCRIPTION

FIG. 1 shows the basic computer model 100 that represents most of today's computers. It has a memory 101, a CPU 102 containing an arithmetic & logic unit, control unit and registers, and an input/output 103.

FIG. 2, illustrates the functional components of the simple computer 200 consisting of a CPU 203, a RAM 202 and input/output devices 201,208, respectively. These components are made very simple so that the system is inexpensive and can be build within a short period of time. For example, the RAM 202 can store only sixteen 4-bit instructions while modern computers store millions of larger instructions and data. Also, while a commercial CPU may implement hundreds of instructions, this teaching aid only handles four instructions. The arithmetic and logic unit (ALU) of a commercial computer has many arithmetic and logic functions such as add, subtract, multiply, divide, is-greater-than, is-equal-to, etc. In the teaching aid there is only one arithmetic function, for example, an adder, and a logical data transfer function.

The Control Unit of the CPU is functionally similar to that of a commercial computer (e.g., it retrieves instructions stored in RAM and executes them), but in the instant invention, the physical size is greatly scaled down.

While most of the components are of limited function and scaled down the overall architectural functionality of the computer is not scaled down. It is the same as or similar to its commercial counterparts. By building the simplified computer, a student will learn the basics of building larger, more complex computers. FIG. 2 shows the computer that is built by the student. Note that the memory is a 16 by 4 Ram and that the Arithmetic Unit 204 contains an adder and a sum register. The Control Unit 205 functions include a clock, a timing Signal Generator, an Instruction Fetch, and an Instruction Execution. The CPU Register set 206 contains two 4-bit registers, Register A and Register B. Also included is a Data Bus 207.

The CPU Instructions include:

Increment Register A

Increment Register B

Move Register A to Register B

Move Register B to Register A.

The Input devices shown are switches (for entering data into RAM) and the OUTPUT devices are light emitting diodes to monitor what is happening at various locations of the computer.

This teaching aid computer is purposely going to be millions of times slower than commercial computers so that one can easily monitor the flow of data and the execution of the instructions that one can build.

The package contains a list of the components already enumerated and a data representation and binary number system as well as logic gates.

FIG. 3 shows the block diagram of the teaching computer 300. It consists of a Timing Signal Generator 301, with Clock, Counter, Decoder and Inverter. The timing signals from this are used in implementing the instruction cycle. These signals travel to the Control Signal Generator 302, which has two AND/OR gate chips for ControlSignals. Registers 303 and 304 are included with their associated Output Buffers. The Ram 305 is connected to Program Counter 305, which also contains an OutputBuffer. Also connected to Ram 305 is Instruction Decoder 306 which contains an inverter, decoder and inverter. Signals from Decoder 306 are forwarded as I₁, I₂, I₃ and I₀ to the Control Signal Generator 302. The Arithmetic Unit 308 receives input from the Bus. Signals from Timing Signal Generator 301 pass to the Control Signal Generator 302 via T₀, etc.

The computer circuit is build on four breadboards, BB1 through BB4, as noted in FIG. 3. The main power supply connects to BB4 and the H1 and Grnd power strips of all four boards interconnect to each other. Each black box on FIG. 3 is an integrated circuit chip.

The teaching computer is designed to execute four instructions that operate on Data-Register A and Data Register-B. These are tabulated below:

| Instruction | Machine Code | Description |
|---|---|---|
| IncA | 0000 | Increments the contents of Register A by one |
| IncB | 0001 | Increments the contents of Register B by one |
| MovAB | 0010 | Moves the contents of Reg. A into Reg. B |
| MovBA | 0011 | Moves the contents of Reg. B into Reg. A |

As an instruction executes, the student will be able to monitor the execution via the LED's that show the contents of these registers, the contents of the program counter, the clock signal the timing signals, and other things you wish to monitor (e.g., the signal for the instruction that is executing, what is on data lines, etc.).

The Timing Signal Generator 301 generates distinct time signals from T₀ to T₉ in repeating cycles. Each cycle executes one instruction and is called an instruction cycle. These time signals are generated at the rate of the clock frequency (e.g., two signals per second). Timing signals are used to trigger certain operations during an instruction cycle.

The BUS is a computer architecture term referring to a number of parallel conductors used by CPU components for exchanging data. The term BUS implies that it is a shared medium. The BUS shown in FIG. 3 consists of four parallel conductors used by several chips for exchanging data. (i.e., a chip puts data on the BUS, another one takes it off).

The Arithmetic Unit 308 performs only a single operation: incrementation. The adder receives the data to be incremented from the BUS and delivers the sum to its output pins. The SUMᵢₙ signal stores the adder output in the Sum Register, and the Sumₒᵤₜ signal opens the buffer gates allowing the sum to flow into the BUS.

Program Counter 305 (PC) chip contains the 4-bit RAM address of an instruction. After an instruction executes, the PC is incremented by one (i.e., via the Arithmetic Unit) and points at the next instruction to execute. Incrementing the PC is implemented in two time steps:

1. At time T₀, the control signal PCₒᵤₜ and Sumᵢₙ are activated. The PCₒᵤₜ signal opens the buffer gates that connect the BUS allowing the PC contents to flow into the adder and the Sumᵢₙ signal store the incremented address in the Sum Register.

2. At time T₁, the control signals Sumₒᵤₜ and PCᵢₙ are activated. The Sumₒᵤₜ Signal opens the buffer gates that connect to the BUS allowing the Sum-Register contents to flow into the BUS and the PCᵢₙ signal allows the incremented address into the PC Register.

The Data Registers A and B each store 4-bits of data. During execution of the instruction MovAB or MovBA, data of the source register flows through the BUS into the destination register. During execution of IncA or IncB, data of the specified register flows through the BUS to the adder and back to the register through the BUS.

RAM 305 contains sixteen 4-bit data locations and it can store sixteen instructions. During programming, one manually specifies these instructions and their RAM locations (i.e., the instruction address) via the switches. During program execution, within each instruction cycle, RAM receives an instruction address from the PC and delivers the 4-bit instruction to the Instruction Decoder.

Instruction Decoder 306 has a circuit that decodes a 4-bit instruction to activate one of the four instruction signals that goes into the Control Signal Encoder. Control Signal Encoder 302 maps the incoming instruction signals and timing signals into control signals which trigger sub-operations within an instruction cycle. The Program Counter is incremented via the first two timing signals of the instruction cycle: the signal T₀ activates PCₒᵤₜ and Sumᵢₙ, and the signal T₁ activates Sumₒᵤₜ and PCᵢₙ. An instruction is executed during the time T₂ and T₃ time steps of the instruction cycle. For example, the instruction IncA is executed via activating the control signals Aₒᵤₜ and Sumᵢₙ at T₂, and activating the signals Aᵢₙ and Sumₒᵤₜ at T₃. One notes that the contents of the Program Counter which is incremented during the first two timing signals stays the same during the rest of the instruction cycle. Therefore, all through T₂ and T₉, RAM output pins contain the same instruction and the Instruction Decoder 306 continuously feeds into the Control Signal Encoder the signal for this instruction.

To operate the teaching aid, one enters his or her program into RAM 305 manually before execution using the data and address switches. As FIG. 4 illustrates, each 4-bit memory location for storing an instruction has a 4-bit address. These addresses range from 0000 to 1111. To write into RAM, the student specifies the memory location via the address switch, specifies the instruction via the data switch, and manually sends to RAM a write signal. The four pins of the data switch connects to RAM's data input pins and the four pins of the address switch connect to RAM's address pins (not shown).

While only one embodiment of this invention has been shown and described in detail it will be obvious to those of ordinary skill in the art to devise other modifications and changes without departing from the scope of the appended claims. For example, one can choose to write one's own codes for the given instructions. To do this, one will have to redesign the wiring in the Instruction Decoder and the Control Signal Encoder accordingly using the design shown herein as an example.

Likewise, the signals T₀, T₁, T₂ and T₃ used in this example can be replaced with other timing signals of the instruction cycle. The chips shown in FIG. 3 can obviously be arranged differently and by adding more breadboards to the package, one can enhance the Arithmetic and Logic Unit by including other chips for division, multiplication subtraction, etc. One can also provide for a larger instruction set to implement those added functions. One could also implement interrupt processing and connect input devices to this mechanism. One can also replace the RAM with a larger RAM, modify the Ram access mechanism (e.g., by including MAR, MBR, and IR registers) and modify the instruction format to support a stack machine or a 1-address, a 2-address, or a 3-address machine. One can also replace the 4-bit simple computer with an 8-bit simple computer.

1. A programmable 4-bit simple teaching computer, said computer comprising
a central memory section,
a central processing unit, and
an input/output section allowing for manual programming of the computer
whereby said computer can be used to teach students the basic architecture of computers.

2. A programmable teaching computer as in claim 1 wherein said computer is designed to accommodate a maximum of sixteen instructions but implements four basic machine language instructions.

3. A programmable teaching computer as in claim 2 and wherein said computer includes light emitting diodes so that students can follow visually the operation of the simple computer.

4. A programmable teaching computer as in claim 1 wherein said memory includes a RAM capable of storing only sixteen 4-bit instructions.

5. A programmable teaching computer as in claim 1 wherein said Central Processing Unit has a arithmetic logic unit having only the add function and no other.

6. A programmable teaching computer as in claim 5 wherein the memory of said computer includes a RAM capable of storing only sixteen 4-bit instructions.

7. A programmable teaching computer as in claim 1 wherein said Central Processing Unit contains an Arithmetic Unit containing only an adder and a Sum Register.

8. A programmable teaching computer as in claim 1 wherein said computer also includes control circuit functions including a clock, a timing signal generator, an instruction fetch and an instruction execution function.

9. A programmable teaching computer as in claim 1 wherein said computer also Includes two Central Processing Unit Registers, both of which are 4-bit register.

10. A programmable teaching computer as in claim 1 wherein said computer's components are all arranged on four bread boards which are interconnected.

11. A programmable teaching computer as in claim 1 and including a Timing Signal Generator with a clock, counter, decoder and inverter.

12. A programmable teaching computer as in claim 1 and including a Control Signal Generator having two AND/OR gate chips.

13. A programmable teaching computer as in claim 1 and including two Registers With output buffers.

14. The programmable teaching computer as in claim 1 wherein said Memory includes a RAM connected to a Program Counter which has an Output Buffer.

15. The programmable teaching computer as in claim 14 wherein an Instruction Decoder is also connected to said RAM.

16. A programmable teaching computer as in claim 1 wherein said computer components are positioned on four bread boards.

17. A programmable teaching computer as in claim 16 wherein a first breadboard contains a Timing Signal Generator.

18. A programmable teaching computer as in claim 17 wherein a second breadboard contains a Program Counter and an Arithmetic Unit.

19. A programmable teaching computer as in claim 18 wherein a third breadboard contains two Data Registers and a Bus consisting of four parallel conductors used by the chips for interchanging data.

20. A programmable teaching computer as in claim 19 wherein a fourth breadboard contains a RAM and an Instruction Decoder.

21. A programmable teaching computer as in claim 19 wherein a Control Signal Generator is located on the second, third and fourth breadboard.

22. A computer kit for use in teaching computer architecture and programming, said kit containing a set of integrated circuit chips for constructing a Central Processing Unit, an input/output component and a Memory, said kit also containing at least four breadboards having power strips.

23. A computer kit as in claim 22 wherein said Memory contains sixteen 4-bit data locations.

24. A computer kit as in claim 22 and including integrated circuit chips, power supply, switches, wire, LEDs, resistors, a capacitor and a lab instruction manual.
